(19) United States
(12) Patent Application Publication
(10) Pub. No.: US 2007/0012050 A1
(43) Pub. Date: Jan. 18, 2007

(54) Thermal method for ice removal under ambient air cryogenic vaporizers

(75) Inventor: Ross M. Brown, Escondido, CA (US)

Correspondence Address: WILLIAM W. HAEFLIGER, 201 S. LAKE AVE, SUITE 512, PASADENA, CA, 91101, US

(73) Assignee: Cryoquip, Inc.

(21) Appl. No.: 11/182,323

(22) Filed: Jul. 18, 2005

(51) Int. Cl. F17C 9/02

(52) U.S. Cl. 62/50.2; 62/275

(57) ABSTRACT

This invention relates prolonging operation duration of ambient air heated vaporizers of cryogenic fluids; and more particularly concerns a method for enhancing ice removal under such vaporizers. Ambient air vaporizers have been used in the past to convert cryogenic fluids into warm gas. Because of the very cold surfaces inherent in the construction of these vaporizers, they collect frost or ice, and are generally limited in the time they can be effective due to the reduction in heat transfer caused by the frozen atmospheric water collecting on vaporizer surfaces. Operators frequently seek to mitigate this effect by having multiple vaporizers, alternately switching units on and off, allowing them to defrost. A characteristic of these defrosting vaporizers, is the falling of the frost and ice off the heat transfer surfaces, collect at the base of the unit (the “Pile). This Pile of frozen water or slush generally can be melted by exposure to warm ambient air during the defrost cycle. The Pile also can be removed manually.

As arrays of vaporizers become larger to service large consumers such as steel mills, or LNG receiving and send-out terminals, frozen water debris at the bases of the heat transfer surfaces is not removed and accumulates over time. The large number of vaporizers units and their relatively close spacing preclude sufficient ambient air circulation to melt the pile. Similarly, it is not practical to remove the pile mechanically.

### SUMMARY OF THE INVENTION

By supplying supplemental heat at the bases of the units, the frost/ice can be melted during a thaw cycle. Then the melted water can be moved by either gravity or a pump to disposal point. The amount of added heat is small relative to the total duty of the unit.

Accordingly, it is a major object of the invention to provide a method of converting cryogenic fluid to gas, which includes the steps a) providing and operating a vaporizer having passages to pass the cool or cold cryogenic fluid in heat transfer relation with warming gas flowing downwardly through the vaporizer,

b) the vaporizer having surfaces on which ice collects and from which ice falls to the base of the vaporizer and collects in a pile,

c) the vaporizer having an operating mode and a thaw mode, d) and transferring heat upwardly into the collected ice in the pile to melt ice in the pile, for removal, as during thawing of the vaporizer.

Another object includes providing an ice collecting space directly beneath the vaporizer, in the path of warming gas.

A further object includes provision of spaced apart leg supports, and supporting the vaporizer on such leg supports adjacent the ice collecting space, whereby melting ice and water can flow between such legs, from said space to the exterior.

Yet another object includes installing heating elements in or on the base, beneath the vaporizer, for transferring heat upwardly to ice in the space below the vaporizer. The heat transfer means may comprise one or more of the following:
i) radiant heaters
ii) warm air flowing means
iii) warm water flowing means
iv) steam jet or jets
v) hot combustion gas flowing means
vi) a heater, and a pump to pump the melting ice and cold water into heat transfer relation with the heater,
vii) heat transfer surface to contact the ice and cold water, and warm media circulating to heat said surfaces,
viii) a heat source embedded in the base.

These and other objects and advantages of the invention, as well as the details of an illustrative embodiment, will be more fully understood from the following specification and drawings, in which:

### DRAWING DESCRIPTION

FIG. 1 is an elevation showing principles of vaporizer operation, during operating mode;

FIG. 2 is an elevation like FIG. 1 showing operation during thaw mode;

FIG. 3 is an enlarged section showing ice collection on a tube that conducts cryogenic fluid upwardly in heat exchange relation with ambient air or other gas flowing downwardly; and

FIG. 4 is a view like FIG. 2, but showing melting ice and water flowing gravitationally from beneath the vaporizer, and to a disposal site.

### DETAILED DESCRIPTION

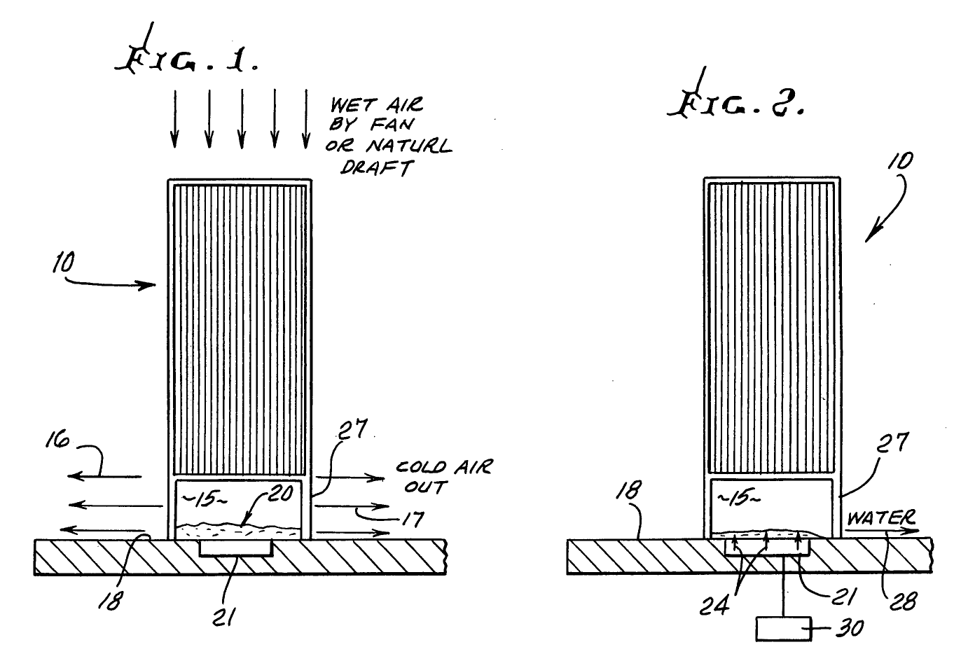

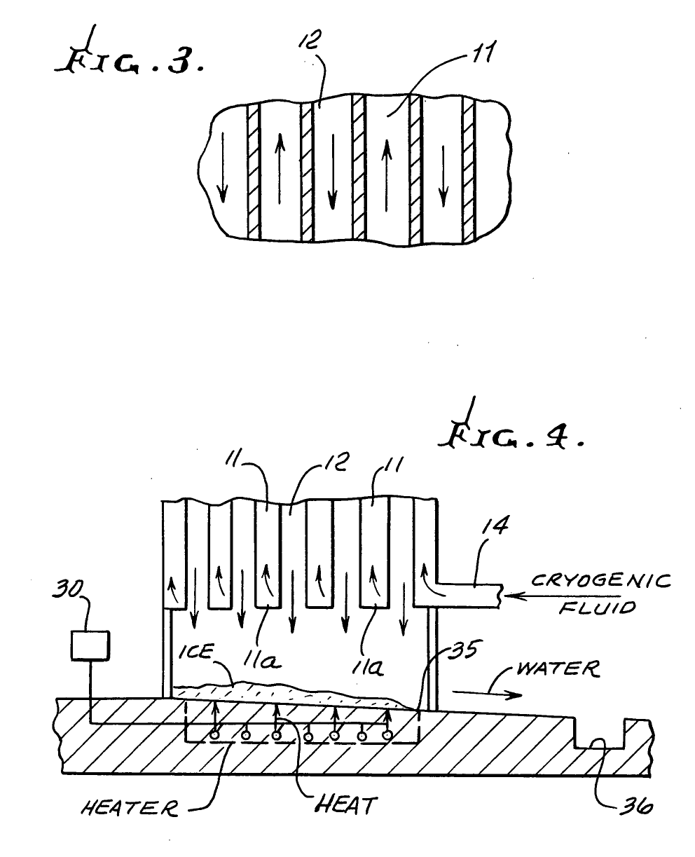

In FIG. 1, each vaporizer unit 10 has passages to pass cryogenic fluid upwardly in passages in heat transfer relation with ambient air flowing downwardly in adjacent passages. FIG. 3 shows such passages 11 and 12 in greater detail. FIG. 4 shows that the cryogenic fluid may be supplied to the bottom inlets 11a to passages 11 via a manifold 14. The vaporized (gasified) cryogenic fluid may be removed as by manifolding at the upper ends of the passages 11. Ambient air normally containing some moisture flows downwardly through the passages 12, which are open at their upper and lower ends, and such cooled air is received in a space 15 below the vaporizer unit. Cold air in space 15 flows laterally, as indicated by arrows 16 and 17 indicating opposite directions of flow, to the exterior, above base 18. As referred to above, ice and frost forms on upright surfaces in the vaporizer, and tends to fall in passages 12 to space 15, where it collects in a pile of ice and slush indicated at 20, thereby increasingly occluding space 15 as the pile grows. A heater or heaters at or near the bottom of space 15 is or are indicated at 21, and is shown as not operating in FIG. 1, but operating in the FIG. 2 thaw mode.

FIG. 2 is like FIG. 1, but shows the vaporizer in thaw mode, with heater or heaters 21 operating to transfer heat to the ice and slush in the pile 20 (see heat transfer arrows 24). As a result, the ice and slush melt to produce cold water flowing laterally at 28 to the exterior of space 15, and between spaced supports or legs 27 supporting the vaporizer. A control 30 is operated to control ON-OFF states of the heater or heaters, as well as the rate of heating as required, for adequate melting of the volumetric extent of the ice and slush pile, to prevent build-up that would inhibit vaporizer efficient operation.

FIG. 4 also shows a sloping of the upper surface 35 of the base, to induce run-off of water, and slush, as toward a disposal means shown in the form of a trench 36. This enhances reduction of the extent of the pile collecting beneath the vaporizer, and contributes to efficiency, as for example reduction in thaw mode time.

As a typical ambient condition, approximately one half the heat required comes from cooling the air, and the other half from condensation and freezing of the water. In the FIG. 2 thaw cycle, between 25% to 75% of the frozen water is melted, the remainder falling to the debris “pile” at the base. The heat to melt the ice is only about 13% of the heat required to condense and freeze. Assuming 50% falls to the base, then only about 7% of the total heat duty is required to melt the ice and slush. What is sufficient is the process of using supplemental heat on the thaw cycle to melt the ice.

Operation may be accomplished in one of several modes, as for example by provision of electric heating coils at the base, switched ON only during the thaw cycle. The same melting effect can achieved using warming methods, such as:
using radiant heaters
blowing warm air over the pile
having heat transfer surfaces with warm media circulating
spraying warm water on the pile
using steam jets
pumping the melt through a heater and spray on the pile
firing a burner and using the combustion gas to melt the pile
having imbedded heat sources in the concrete (driveway heating coils).

Apparatus as described and shown is preferred.

I claim:

1. In apparatus to convert cryogenic fluid to gas,
a) a vaporizer having passages to pass the cool or cold cryogenic fluid in heat transfer relation with warming gas flowing downwardly through the vaporizer,
b) the vaporizer having surfaces on which ice collects and from which ice falls to the base of the vaporizer and collects in a pile,
c) and means for transferring heat to the collected ice in the pile to melt ice in the pile, for removal, during thawing of the vaporizer.

2. The apparatus of claim 1 wherein there is an ice collecting space directly beneath the vaporizer.

3. The apparatus of claim 2 wherein the vaporizer is supporting by spaced apart legs adjacent said space, whereby melting ice and water can flow between said legs, from said space to the exterior.

4. The apparatus of claim 1 wherein said means includes heating elements installed in or on said base, beneath the vaporizer for transferring heat to ice in said space.

5. The apparatus of claim 4 wherein said elements include electrical coils.

6. The apparatus of claim 1 wherein said heat transfer means comprises one or more of the following:
i) radiant heaters
ii) warm air flowing means
iii) warm water flowing means
iv) steam jet or jets
v) hot combustion gas flowing means
vi) a heater, and a pump to pump the melting ice and cold water into heat transfer relation with the heater
vii) heat transfer surface to contact the ice and cold water, and warm media circulating to heat said surfaces
viii) a heat source embedded in the base.

7. The apparatus of claim 1 including said cryogenic fluid flowing in the vaporizer.

8. The apparatus of claim 7 wherein said cryogenic fluid consists of LNG.

9. The method of converting cryogenic fluid to gas, which includes the steps:
a) providing and operating a vaporizer having passages to pass the cool or cold cryogenic fluid in heat transfer relation with warming gas flowing downwardly through the vaporizer,
b) the vaporizer having surfaces on which ice collects and from which ice falls to the base of the vaporizer and collects in a pile,
c) the vaporizer having an operating mode and a thaw mode,
d) and transferring heat to the collected ice in the pile to melt ice in the pile, for removal, during thawing mode of the vaporizer.

10. The method of claim 9 including providing an ice collecting space directly beneath the vaporizer.

11. The method of claim 10 including providing spaced apart leg supports, and supporting the vaporizer on said leg supports adjacent said space, whereby melting ice and water can flow between said legs, from said space to the exterior.

12. The method of claim 9 including providing heating elements installed in or on said base, beneath the vaporizing for transferring heat to the collected ice.

13. The method of claim 12 wherein said heating elements are electrical heating elements.

14. The method of claim 9 wherein said heat transfer to ice in the pile is effected by providing and operating at least one of the following:
i) radiant heaters
ii) warm air flowing means
iii) warm water flowing means
iv) steam jet or jets
v) hot combustion gas flowing means
vi) a heater, and a pump to pump the melting ice and cold water into heat transfer relation with the heater
vii) heat transfer surface to contact the ice and cold water, and warm media circulating to heat said surfaces
viii) a heat source embedded in the base.

15. The method of claim 9 including said cryogenic fluid flowing in the vaporizer.

16. The method of claim 5 wherein said cryogenic fluid is LNG.
